(19) United States
(12) Patent Application Publication
(10) Pub. No.: US 2026/0307988 A1
(43) Pub. Date: Oct. 8, 2026

(54) APPARATUS FOR PRODUCING HYDROGEN GAS

(71) Applicants: HYUNDAI MOTOR COMPANY, SEOUL (KR); KIA CORPORATION, SEOUL (KR)

(72) Inventors: Han Eol Song, Seongnam-si (KR); Woo Ram Kang, Suwon-si (KR)

(73) Assignees: HYUNDAI MOTOR COMPANY, SEOUL (KR); KIA CORPORATION, SEOUL (KR)

(21) Appl. No.: 19/710,222

(22) Filed: Jun. 16, 2026

Related U.S. Application Data
(62) Division of application No. 17/881,575, filed on Aug. 4, 2022.

(30) Foreign Application Priority Data
Mar. 17, 2022 (KR) 10-2022-0033610

(51) Int. Cl. C01B 3/56

(52) U.S. Cl. CPC C01B 3/56; C01B 2203/0485

(57) ABSTRACT

Disclosed is an apparatus for producing a hydrogen gas according to the present disclosure. The apparatus includes a desulfurizer, a plasma reactor, a separator, a first heat exchanger, a second heat exchanger, and a first adsorber, and circulates at least a portion of a first off gas to the plasma reactor again.

### CROSS REFERENCE TO RELATED APPLICATIONS

This application is a divisional of U.S. patent application Ser. No. 17/881,575, filed Aug. 4, 2022, which claims the benefit of priority to Korean Patent Application No. 10-2022-0033610, filed in the Korean Intellectual Property Office on Mar. 17, 2022, the entire contents of which are incorporated herein by reference.

### TECHNICAL FIELD

The present disclosure relates to a producing apparatus that may manufacture a hydrogen gas of a high purity while showing excellent energy efficiency by increasing a temperature of a material by utilizing wasted heat of the produced hydrogen gas.

### BACKGROUND

In recent years, a hydrogen gas has been spotlighted as an eco-friendly energy source, and thus various methods for producing a hydrogen gas have been suggested. Among the methods for producing a hydrogen gas, a method for plasma-treating a hydrocarbon containing material is eco-friendly as it generates a small amount of side-products such as carbon dioxide. Generally, a material is converted into hydrogen and carbon (for example, carbon black) by decomposing the material in the method for producing a hydrocarbon using plasma. In detail, in the producing method, a plasma state of a high temperature is maintained by igniting air or a plasma gas with an electric arc in an interior of a plasma generator, and a hydrocarbon containing material is converted to hydrogen and carbon by bringing the hydrocarbon containing material into reaction with plasma. Then, because a startup/response time is rapid due to a self-heat of plasma and an internal reaction heat due to thermal decomposition, it is suitable for a large amount of the material and a property of the gas.

For example, Korean Patent No. 1594350 (Patent Document 1) discloses an apparatus for producing hydrogen by using steam plasma, including a steam plasma torch connected to a steam boiler and a microwave generator, a gasification reactor that generates a synthetic gas by bringing stream plasma-activated by microwaves of the microwave generator and powered coal into reaction with each other with flames of a plasma torch at a high temperature; and a heat recovery stream boiler that recovers heat from the synthetic gas of the gasification reactor. However, the conventional method or apparatus for producing hydrogen by using plasma in Patent document 1 requires an operation of additionally purifying carbon monoxide, dust, and the like, which are impurities, which are much included in a synthetic gas generated by using hydrocarbon in a solid state as a material, and has a low energy efficiency as wasted heat of the produced hydrogen is discharged to the air.

### SUMMARY

The present disclosure has been made to solve the above-mentioned problems occurring in the prior art while advantages achieved by the prior art are maintained intact.

An aspect of the present disclosure provides an apparatus for producing a hydrogen gas, which does not require additional purification of hydrogen as a purity of the produced hydrogen is high and has excellent energy efficiency by utilizing wasted heat of the produced hydrogen.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for producing a hydrogen gas includes, a desulfurizer that desulfurizes a hydrocarbon containing gas, a plasma reactor that generates a hydrogen containing gas from the desulfurized hydrocarbon containing gas through plasma based pyrolysis, a separator that separates a low-purity hydrogen gas from the hydrogen containing gas, a first heat exchanger that exchanges heat between the desulfurized hydrocarbon containing gas and the low-purity hydrogen gas, a second heat exchanger that exchanges heat between the hydrocarbon containing gas and the low-purity hydrogen gas that exchanged heat in the first heat exchanger, and a first adsorber that separates the low-purity hydrogen gas that exchanged heat in the second heat exchanger into a first high-purity hydrogen gas and a first off gas, through adsorption, and at least a portion of the first off gas is circulated to the plasmas reactor again.

According to an aspect of the present disclosure, an apparatus for producing a hydrogen gas includes, a desulfurizer that desulfurizes a hydrocarbon containing gas, a plasma reactor that generates a hydrogen containing gas from the desulfurized hydrocarbon containing gas through plasma based pyrolysis, a separator that separates a low-purity hydrogen gas from the hydrogen containing gas, a first heat exchanger that exchanges heat between the desulfurized hydrocarbon containing gas and the low-purity hydrogen gas, a second heat exchanger that exchanges heat between the hydrocarbon containing gas and the low-purity hydrogen gas that exchanged heat in the first heat exchanger, a first adsorber that separates the low-purity hydrogen gas that exchanged heat in the second heat exchanger into a first high-purity hydrogen gas and a first off gas, through adsorption, and a second adsorber that separates the first off gas to a second high-purity hydrogen gas and a second off gas through adsorption.

### BRIEF DESCRIPTION OF THE FIGURES

The above and other objects, features and advantages of the present disclosure will be more apparent from the following detailed description taken in conjunction with the accompanying drawings:

FIG. 1 is a flowchart of an apparatus for producing a hydrogen gas according to an embodiment of the present disclosure.

FIG. 2 is a flowchart of an apparatus for producing a hydrogen gas according to an embodiment of the present disclosure.

FIG. 3 is a flowchart of an apparatus for producing a hydrogen gas according to an embodiment of the present disclosure.

FIG. 4 is a flowchart of an apparatus for producing a hydrogen gas according to an embodiment of the present disclosure.

FIG. 5 is a flowchart of an apparatus for producing a hydrogen gas according to an embodiment of the present disclosure.

FIG. 6 is a flowchart of an apparatus for producing a hydrogen gas according to an embodiment of the present disclosure.

FIG. 7 is a flowchart of an apparatus for producing a hydrogen gas according to an embodiment of the present disclosure.

FIG. 8 is a flowchart of an apparatus for producing a hydrogen gas according to an embodiment of the present disclosure.

FIG. 9 is a flowchart of an apparatus for producing a hydrogen gas according to an embodiment of the present disclosure.

FIG. 10 is a flowchart of an apparatus for producing a hydrogen gas according to an embodiment of the present disclosure.

### DETAILED DESCRIPTION

Hereinafter, the present disclosure will be described in detail.

### Apparatus for Producing Hydrogen Gas (a First Embodiment Form)

An apparatus for producing a hydrogen gas according to the present disclosure includes a desulfurizer, a plasma reactor, a separator, a first heat exchanger, a second heat exchanger, and a first adsorber, and circulates at least a portion of a first off gas to the plasma reactor again.

### Desulfurizer

The desulfurizer functions to remove sulfur(S) components from a hydrocarbon containing gas.

Generally, any device that may be used to remove sulfur components from the hydrocarbon containing gas may be used as the desulfurizer without any limitation. For example, the desulfurizer may be one, to which a general desulfurization method such as desulfurization through hydrogen purification, desulfurization using addition of acids, or desulfurization using addition of alkalis.

### Plasma Reactor

The plasma reactor generates a hydrogen containing gas by plasma-treating the desulfurized hydrocarbon containing gas.

The plasma-based pyrolysis may be an operation of mixing the desulfurized hydrocarbon containing gas and plasma and bringing them into reaction with each other.

Then, any plasma that may be generally used when hydrogen is produced without limitation, and for example, may be high-temperature plasma, and for example, a temperature of the plasma may be in a range of 800° C. to 50,000° C. As described above, when the high-temperature plasma is used when the plasma is treated, a hydrogen production efficiency may be improved due to a high conversion rate.

Furthermore, the plasma, for example, may be microwave plasma, arc plasma, and the like.

The plasma reactor may include a plasma generating part that generates plasma, and a reaction part that mixes the desulfurized hydrocarbon containing gas and the plasma introduced from the plasma generating part and brings them into reaction with each other.

### Separator

The separator separates a low-purity hydrogen gas from the hydrogen containing gas. In detail, the separator may separate side-products including the low-purity hydrogen gas and carbon from the hydrogen containing gas.

A temperature of the low-purity hydrogen gas separated by the separator may be 500° C. to 2,500° C. or 800° C. to 2,000° C., in certain embodiments. The low-purity hydrogen gas separated by the separator is of a high temperature, and the apparatus for producing a hydrogen gas according to the present disclosure has an excellent energy efficiency by using wasted heat of the hydrogen gas of the high temperature in preheating of the hydrocarbon containing gas that is a source material introduced into the plasma reactor.

### First Heat Exchanger

The first heat exchanger exchanges heat between the low-purity hydrogen gas separated by the separator and the hydrocarbon containing gas desulfurized by the desulfurizer. Accordingly, a temperature of the hydrogen gas separated by the separator decreases, and a temperature of the desulfurized hydrocarbon containing gas increases. That is, the wasted heat of the hydrogen gas of a high temperature is used for preheating the hydrocarbon containing gas that is a material introduced into the plasma reactor.

Any device that may be generally applied to exchange heat between a gas of a high temperature and a gas of a low temperature may be used as the first heat exchanger without any particular limitation.

### Second Heat Exchanger

The second heat exchanger exchanges heat between the low-purity hydrogen gas that exchanged heat in the first heat exchanger and the hydrocarbon containing gas. Accordingly, the temperature of the hydrogen gas, which has exchanged hat in the first heat exchanger, decreases, and the temperature of the hydrocarbon containing gas that is a material introduced into the desulfurizer increases. That is, the wasted heat of the hydrogen gas of a high temperature is used for preheating the hydrocarbon containing gas that is a material introduced into the desulfurizer.

Any device that may be generally applied to exchange heat between a gas of a high temperature and a gas of a low temperature may be used as the second heat exchanger without any particular limitation.

### First Adsorber

The first adsorber separates the low-purity hydrogen gas that exchanged heat in the second heat exchanger to a first high-purity hydrogen gas and a first off gas, through adsorption. Then, at least a portion of the separated first off gas is circulated to the plasma reactor again.

Any device that may generally remove impurities in the hydrogen gas may be used as the first adsorber without particular limitation, and for example, may be performed through pressure swing adsorption (PSA).

The first adsorber may include four to twelve adsorption towers, and the adsorption towers may be filled with an adsorption agent, and then, the adsorption agent, for example, may include a carbon-based material, a zeolite-based material, and the like, and in detail, may include activated carbon, aluminosilicate, pure silicate, titanosilicate, and aluminophosphate.

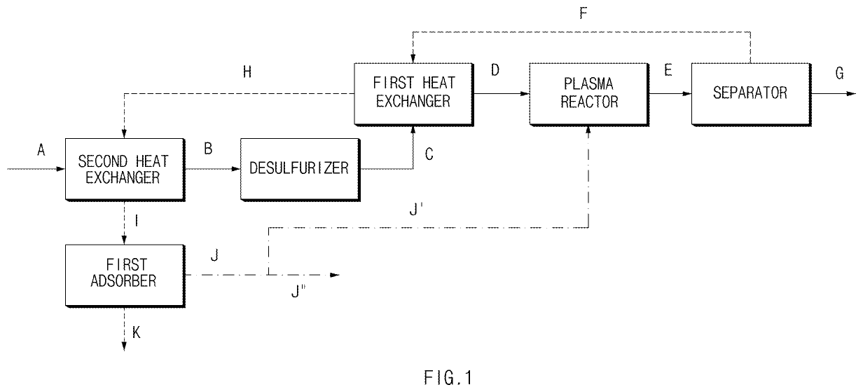

Referring to FIG. 1, the apparatus for producing a hydrogen gas according to the present disclosure may include the second heat exchanger that exchanges heat between the hydrocarbon containing gas “A” before being introduced into the desulfurizer and the low-purity hydrogen gas “H” that exchanged heat in the first heat exchanger, the desulfurizer that desulfurizes the hydrocarbon containing gas “B” that exchanged heat in the second heat exchanger, the first heat exchanger that exchanges heat between the desulfurized hydrocarbon containing gas “C” and the low-purity hydrogen gas “F” separated by the separator, the plasma reactor that generates the hydrogen containing gas “E” from the hydrocarbon containing gas “D” that exchanged heat in the first heat exchanger and was desulfurized, through plasma based pyrolysis, the separator that separates side-products “G” including the low-purity hydrogen gas “F” and carbon from the hydrogen containing gas “E”, and the first adsorber that separates the low-purity hydrogen gas “I” that exchanged heat in the second heat exchanger to the first high-purity hydrogen gas “K” and the first off gas “J” through adsorption. Then, at least a portion J′ of the first off gas “J” may be circulated to the plasma reactor again.

A volume of the first off gas that is circulated to the plasma reactor may be more than 0 volume % and not more than 100 volume % or 40 volume % to 90 volume % of a total volume of the first off gas discharged from the first adsorber. Referring to FIG. 1, the first off gas J″ corresponding to more than 0 volume % and not more than 100 volume % or 40 volume % to 90 volume % of the total volume of the first off gas “J” discharged from the first adsorber is circulated to the plasma reactor again. When the volume % of the first off gas that is circulated to the plasma reactor again is within the range, an amount of a material that is introduced into the plasma reactor is reduced.

The first off gas J′ that is circulated to the plasma reactor again may be compressed. For example, the apparatus for producing the hydrogen gas may further include a second compressor that compresses the first off gas that is circulated from the first adsorber to the plasma reactor again.

### Second Compressor

The second compressor functions to compress at least a portion of the first off gas, which was discharged from the first adsorber, and supply the compressed at least portion of the first off gas to the plasma reactor.

A pressure of the first off gas compressed by the second compressor may be 0.5 MPa to 5.0 MPa or 1.0 MPa to 3.5 MPa, in certain embodiments. When the pressure of the compressed first off gas is less than the range, it may be impossible to inject the first off gas into the plasma reactor as the fuel supply pressure is not reached, and when the pressure is more than the range, the pressure may exceed a design pressure of a fuel supply system.

The apparatus for producing a hydrogen gas may further include a flare stack that burns and discharges the remaining portions of the first off gas, which was not introduced into the second compressor.

### Flare Stack

The first off gas that was not introduced into the second adsorber may be burned in the flare stack and be discharged to the air. Then, any device that may be applied to generally burn a gas and discharge the gas to the air may be applied as the flare stack without particular limitation.

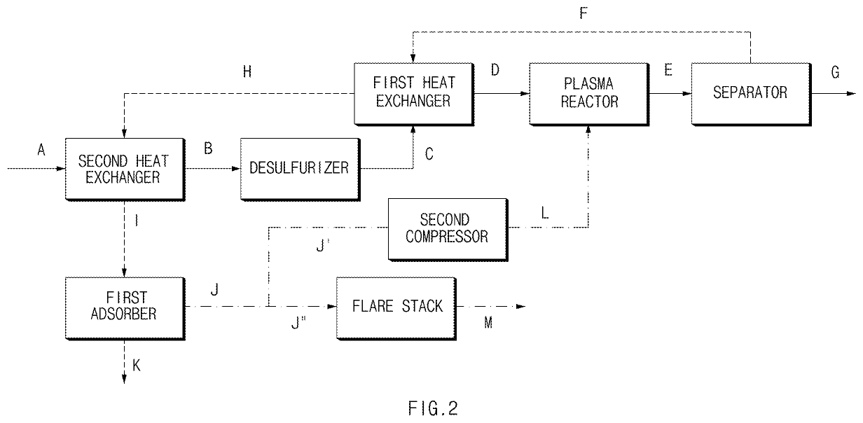

Referring to FIG. 2, the apparatus for producing a hydrogen gas according to the present disclosure may include the second heat exchanger that exchanges heat between the hydrocarbon containing gas “A” before being introduced into the desulfurizer and the low-purity hydrogen gas “H” that exchanged heat in the first heat exchanger, the desulfurizer that desulfurizes the hydrocarbon containing gas “B” that exchanged heat in the second heat exchanger, the first heat exchanger that exchanges heat between the desulfurized hydrocarbon containing gas “C” and the low-purity hydrogen gas “F” separated by the separator, the plasma reactor that generates the hydrogen containing gas “E” from the hydrocarbon containing gas “D” that exchanged heat in the first heat exchanger and was desulfurized, through plasma based pyrolysis, the separator that separates the hydrogen containing gas “E” into the low-purity hydrogen gas “F” and side-products “G” including carbon, and the first adsorber that separates the low-purity hydrogen gas “I” that exchanged heat in the second heat exchanger to the first high-purity hydrogen gas “K” and the first off gas “J” through adsorption. Then, the at least a portion J′ of the first off gas “J” may be circulated to the plasma reactor again, and the first off gas J′ that is circulated to the plasma reactor again may be compressed in the second compressor.

Further, the first off gas J″ that was not introduced into the second adsorber may be burned in the flare stack and be discharged to the air.

The apparatus for producing a hydrogen gas according to the present disclosure may further include, between the first heat exchanger and the second heat exchanger, a third heat exchanger. That is, the first off gas that is recirculated to the plasma reactor may be preheated in the third heat exchanger, and thus, energy for generating plasma in the plasma reactor is reduced.

### Third Heat Exchanger

The third heat exchanger exchanges heat between the low-purity hydrogen gas that exchanged heat in the first heat exchanger, and at least a portion of the first off gas discharged from the first adsorber. Accordingly, the temperature of the low-purity hydrogen gas that exchanged heat in the first heat exchanger decreases, and the temperature of the first off gas introduced into the plasma reactor increases. That is, the wasted heat of the hydrogen gas of the high temperature is used to preheat the first off gas that is circulated to the plasma reactor again.

Any heat exchanger that may be generally applied to exchange heat between a gas of a high temperature and a gas of a low temperature may be used as the third heat exchanger without any particular limitation.

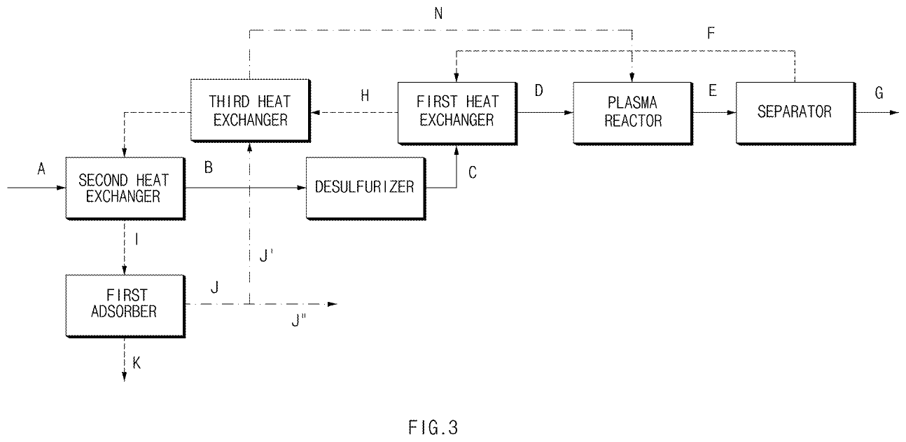

Referring to FIG. 3, the apparatus for producing a hydrogen gas according to the present disclosure may include the second heat exchanger that exchanges heat between the hydrocarbon containing gas “A” before being introduced into the desulfurizer and the low-purity hydrogen gas “H” that exchanged heat in the first heat exchanger, the desulfurizer that desulfurizes the hydrocarbon containing gas “B” that exchanged heat in the second heat exchanger, the first heat exchanger that exchanges heat between the desulfurized hydrocarbon containing gas “C” and the low-purity hydrogen gas “F” separated by the separator, the plasma reactor that generates the hydrogen containing gas “E” from the hydrocarbon containing gas “D” that exchanged heat in the first heat exchanger and was desulfurized, through plasma based pyrolysis, the separator that separates side-products “G” including the low-purity hydrogen gas “F” and carbon from the hydrogen containing gas “E”, and the first adsorber that separates the low-purity hydrogen gas “I” that exchanged heat in the second heat exchanger to the first high-purity hydrogen gas “K” and the first off gas “J” through adsorption. Then, the at least a portion J′ of the first off gas “J” may be circulated to the plasma reactor again, and the first off gas J′ that circulated again may exchange heat with the low-purity hydrogen gas “H” that exchanged heat in the first heat exchanger. Furthermore, the first off gas “N” that exchanged heat in the third heat exchanger and was preheated may be circulated to the plasma reactor again.

The apparatus for producing a hydrogen gas according to the present disclosure may further include, between the second heat exchanger and the first adsorber, a cooler and a first compressor.

### Cooler and First Compressor

The cooler functions to enhance an adsorption efficiency by cooling the low-purity hydrogen gas that exchanged heat in the second heat exchanger.

In detail, the temperature of the low-purity hydrogen gas that exchanged heat in the second heat exchanger may be 150° C. to 700° C. or 200° C. to 650° C. That is, the low-purity hydrogen gas that is discharged after exchanging heat in the second heat exchanger is of a high temperature. Accordingly, the producing apparatus according to the present disclosure may further include the cooler that cools the low-purity hydrogen gas that was discharged after exchanging heat in the second heat exchanger before being adsorbed by the first adsorber to enhance adsorption efficiency.

Furthermore, any device that may lower the temperature of the hydrogen gas may be used without any particular limitation as the cooler, and for example, may be a heat exchange type cooler. Then, the heat exchange type cooler may cool the hydrogen gas by exchanging heat between a refrigerant and the hydrogen gas, and the refrigerant, for example, may include water, an antifreeze, and a thermal medium oil.

The hydrogen gas cooled by the cooler may be 10° C. to 80° C. or 10° C. to 60° C., in certain embodiments. When the temperature of the cooled hydrogen gas is less than the range, economic efficiency may decrease due to excessive cooling, and when the temperature is more than the range, the adsorption agent filled in the first adsorber may be damaged.

The first compressor functions to enhance an adsorption efficiency by compressing the low-purity hydrogen gas cooled by the cooler. When the performance of the first adsorber is made by the PSA, the adsorption effect of the impurities in the hydrogen gas becomes lower when the pressure of the supplied hydrogen gas becomes lower. Accordingly, the hydrogen gas introduced into the first adsorber may be introduced into the first adsorber after being compressed by the first compressor.

Furthermore, any device that may be used to generally compress the hydrogen gas may be used as the first compressor without any particular limitation.

Then, the pressure of the low-purity hydrogen gas compressed by the first compressor may be 0.5 MPa to 5.0 MPa or 1.0 MPa to 3.5 MPa. When the pressure of the low-purity hydrogen gas compressed by the first compressor is less than the range, the effect of adsorbing impurities in the low-purity hydrogen gas decreases, and when the pressure is more than the range, the adsorption agent filled in the first adsorber may be damaged.

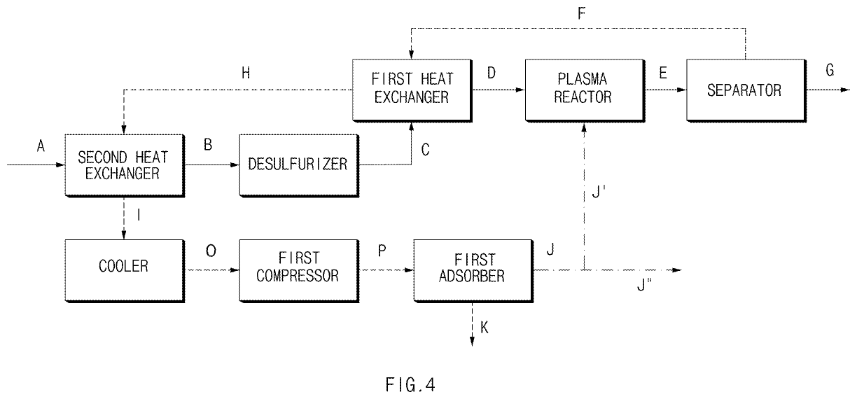

Referring to FIG. 4, the apparatus for producing a hydrogen gas according to the present disclosure may include the second heat exchanger that exchanges heat between the hydrocarbon containing gas “A” before being introduced into the desulfurizer and the low-purity hydrogen gas “H” that exchanged heat in the first heat exchanger, the desulfurizer that desulfurizes the hydrocarbon containing gas “B” that exchanged heat in the second heat exchanger, the first heat exchanger that exchanges heat between the desulfurized hydrocarbon containing gas “C” and the low-purity hydrogen gas “F” separated by the separator, the plasma reactor that generates the hydrogen containing gas “E” from the hydrocarbon containing gas “D” that exchanged heat in the first heat exchanger and was desulfurized, through plasma based pyrolysis, the separator that separates side-products “G” including the low-purity hydrogen gas “F” and carbon from the hydrogen containing gas “E”, the cooler that cools the low-purity hydrogen gas “I” that exchanged heat in the second heat exchanger, the first compressor that compresses the low-purity hydrogen gas “O” cooled by the cooler, and the first adsorber that separates the low-purity hydrogen gas “P” compressed by the first compressor to the first high-purity hydrogen gas “K” and the first off gas “J” through adsorption. Then, at least a portion J′ of the first off gas “J” may be circulated to the plasma reactor again.

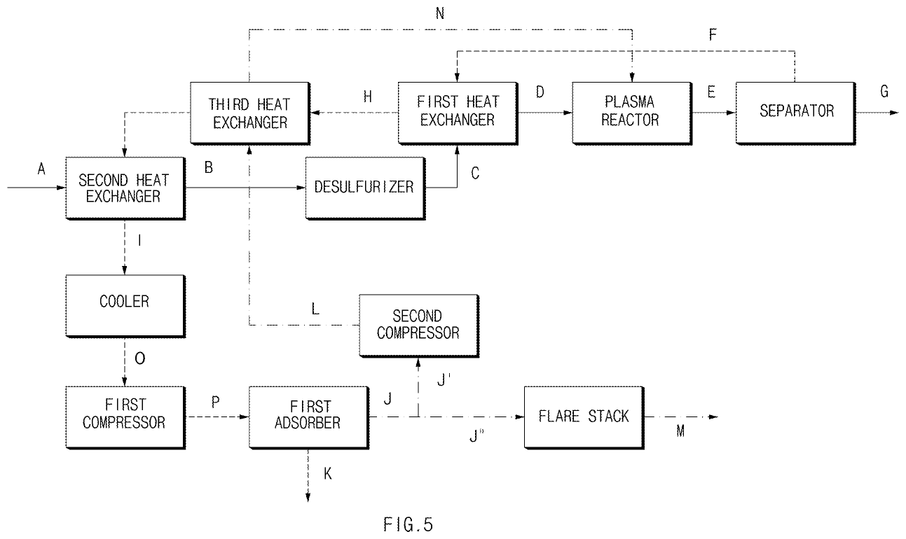

Referring to FIG. 5, the apparatus for producing a hydrogen gas according to the present disclosure may include the second heat exchanger that exchanges heat between the hydrocarbon containing gas “A” before being introduced into the desulfurizer and the low-purity hydrogen gas “H” that exchanged heat in the first heat exchanger, the desulfurizer that desulfurizes the hydrocarbon containing gas “B” that exchanged heat in the second heat exchanger, the first heat exchanger that exchanges heat between the desulfurized hydrocarbon containing gas “C” and the low-purity hydrogen gas “F” separated by the separator, the plasma reactor that generates the hydrogen containing gas “E” from the hydrocarbon containing gas “D” that exchanged heat in the first heat exchanger and was desulfurized, through plasma based pyrolysis, the separator that separates side-products “G” including the low-purity hydrogen gas “F” and carbon from the hydrogen containing gas “E”, the cooler that cools the low-purity hydrogen gas “I” that exchanged heat in the second heat exchanger, the first compressor that compresses the low-purity hydrogen gas “O” cooled by the cooler, and the first adsorber that separates the low-purity hydrogen gas “P” compressed by the first compressor to the first high-purity hydrogen gas “K” and the first off gas “J” through adsorption. Then, the at least a portion J′ of the first off gas “J” may be circulated to the plasma reactor again, and the first off gas J′ that is circulated again may be compressed by second compressor, and the first off gas “L” compressed by second compressor may exchange heat with the low-purity hydrogen gas “H” that exchanged heat in the first heat exchanger. Furthermore, the first off gas “N” that exchanged heat in the third heat exchanger and was preheated may be circulated to the plasma reactor again. Meanwhile, the first off gas J″ that was not introduced into the second adsorber may be burned in the flare stack and be discharged to the air.

The high-purity hydrogen gas K produced by the above-described apparatus for producing a hydrogen gas may be used as a material, such as a fuel cell, without using additional purification due to a high purity of 99.97% or more.

### Apparatus for Producing Hydrogen Gas (a Second Embodiment Form)

The method for producing a hydrogen gas according to the present disclosure includes the desulfurizer, the plasma reactor, the separator, the first heat exchanger, the second heat exchanger, the first adsorber, and the second adsorber.

### Desulfurizer

The desulfurizer functions to remove sulfur(S) components from a hydrocarbon containing gas.

Generally, any device that may be used to remove sulfur components from the hydrocarbon containing gas may be used as the desulfurizer without any limitation. For example, the desulfurizer may be one, to which a general desulfurization method such as desulfurization through hydrogen purification, desulfurization using addition of acids, or desulfurization using addition of alkalis.

### Plasma Reactor

The plasma reactor generates a hydrogen containing gas by plasma-treating the desulfurized hydrocarbon containing gas.

The plasma-based pyrolysis may be an operation of mixing the desulfurized hydrocarbon containing gas and plasma and bringing them into reaction with each other.

Then, any plasma that may be generally used when hydrogen is produced may be used without limitation, and for example, may be high-temperature plasma, and for example, a temperature of the plasma may be 800° C. to 50,000° C., in certain embodiments. As described above, when the high-temperature plasma is used when the plasma is treated, a hydrogen production efficiency may be improved due to a high conversion rate.

Furthermore, the plasma, for example, may be microwave plasma, arc plasma, and the like.

The plasma reactor may include a plasma generating part that generates plasma, and a reaction part that mixes the desulfurized hydrocarbon containing gas and the plasma introduced from the plasma generating part and brings them into reaction with each other.

### Separator

The separator separates a low-purity hydrogen gas from the hydrogen containing gas. In detail, the separator may separate side-products including the low-purity hydrogen gas and carbon from the hydrogen containing gas.

A temperature of the low-purity hydrogen gas separated by the separator may be 500° C. to 2,500° C. or 800° C. to 2,000° C., in certain embodiments. The low-purity hydrogen gas separated by the separator is of a high temperature, and the apparatus for producing a hydrogen gas according to the present disclosure has an excellent energy efficiency by using wasted heat of the hydrogen gas of the high temperature in preheating of the hydrocarbon containing gas that is a source material introduced into the plasma reactor.

### First Heat Exchanger

The first heat exchanger exchanges heat between the low-purity hydrogen gas separated by the separator and the hydrocarbon containing gas desulfurized by the desulfurizer. Accordingly, a temperature of the hydrogen gas separated by the separator decreases, and a temperature of the desulfurized hydrocarbon containing gas increases. That is, the wasted heat of the low-purity hydrogen gas of a high temperature is used for preheating the hydrocarbon containing gas that is a material introduced into the plasma reactor.

Any heat exchanger that may be generally applied to exchange heat between a gas of a high temperature and a gas of a low temperature may be used without any particular limitation.

### Second Heat Exchanger

The second heat exchanger exchanges heat between the low-purity hydrogen gas that exchanged heat in the first heat exchanger and the hydrocarbon containing gas. Accordingly, the temperature of the low-purity hydrogen gas that exchanged heat in the first heat exchanger decreases, and the temperature of that is a material introduced into the desulfurizer increases. That is, the wasted heat of the low-purity hydrogen gas of a high temperature is used for preheating the hydrocarbon containing gas that is a material introduced into the desulfurizer.

Any heat exchanger that may be generally applied to exchange heat between a gas of a high temperature and a gas of a low temperature may be used as the second heat exchanger without any particular limitation.

### First Adsorber

The first adsorber separates the low-purity hydrogen gas that exchanged heat in the second heat exchanger to a first high-purity hydrogen gas and a first off gas, through adsorption.

Any device that may generally remove impurities in the hydrogen gas may be used as the first adsorber without particular limitation, and for example, may be performed through pressure swing adsorption (PSA).

The first adsorber may include four to twelve adsorption towers, and the adsorption towers may be filled with an adsorption agent, and then, the adsorption agent, for example, may include a carbon-based material, a zeolite-based material, and the like, and in detail, may include activated carbon, aluminosilicate, pure silicate, titanosilicate, and aluminophosphate.

### Second Adsorber

The second adsorber separates the first off gas separated by the first adsorber to a second high-purity hydrogen gas and a second off gas through adsorption.

Any device that may generally remove impurities in the hydrogen gas may be used as the second adsorber without particular limitation, and for example, may be performed through pressure swing adsorption (PSA).

The second adsorber may include four to twelve adsorption towers, and the adsorption towers may be filled with an adsorption agent, and then, the adsorption agent, for example, may include a carbon-based material, a zeolite-based material, and the like, and in detail, may include activated carbon, aluminosilicate, pure silicate, titanosilicate, and aluminophosphate.

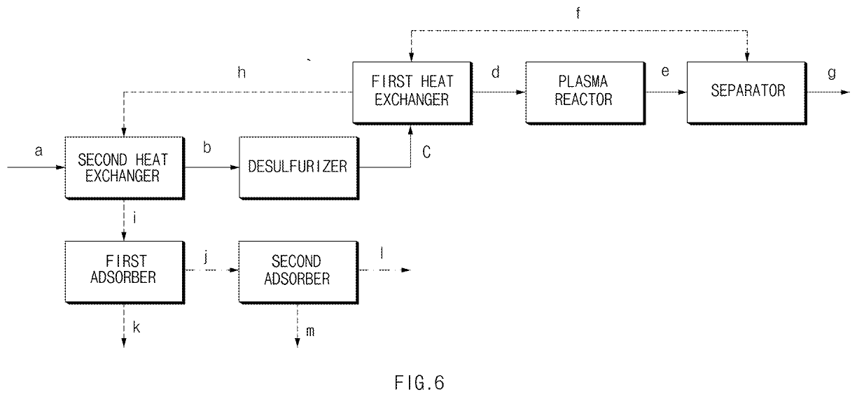

Referring to FIG. 6, the apparatus for producing a hydrogen gas according to the present disclosure may include the second heat exchanger that exchanges heat between the hydrocarbon containing gas “a” before being introduced into the desulfurizer and the low-purity hydrogen gas “h” that exchanged heat in the first heat exchanger, the desulfurizer that desulfurizes the hydrocarbon containing gas “b” that exchanged heat in the second heat exchanger, the first heat exchanger that exchanges heat between the desulfurized hydrocarbon containing gas “c” and the low-purity hydrogen gas “f” separated by the separator, the plasma reactor that generates the hydrogen containing gas “e” from the hydrocarbon containing gas “d” that exchanged heat in the first heat exchanger and was desulfurized, through plasma based pyrolysis, the separator that separates side-products “g” including the low-purity hydrogen gas “f” and carbon from the exchanged heat in the second heat exchanger to the first high-purity hydrogen gas “k” and the first off gas “j” through adsorption, and the second adsorber that separates the first off gas “j” to the second high-purity hydrogen gas “m” and the second off gas “1” through adsorption.

Between the first adsorber and the second adsorber, the first off gas discharged from the first adsorber may be compressed. For example, the apparatus for producing the hydrogen gas may further include a second compressor that compresses the first off gas that is discharged from the first adsorber.

### Second Compressor

The second compressor functions to increase an adsorption effect of the second adsorber by compressing the first off gas discharged from the first adsorber and supplying the first off gas to the second adsorber. When the performance of the second adsorber is made by the PSA, the adsorption effect of the impurities in the hydrogen gas becomes lower when the pressure of the supplied hydrogen gas becomes lower. Accordingly, the first gas introduced into the second adsorber may be introduced into the second adsorber after being compressed by the second compressor.

Furthermore, a pressure of the first off gas compressed by the second compressor may be 0.5 MPa to 5.0 MPa or 1.0 MPa to 3.5 MPa, in certain embodiments. When the pressure of the compressed first off gas is less than the range, the effect of adsorbing impurities in the first off gas decreases, and when the pressure is more than the range, the adsorption agent filled in the second adsorber may be damaged.

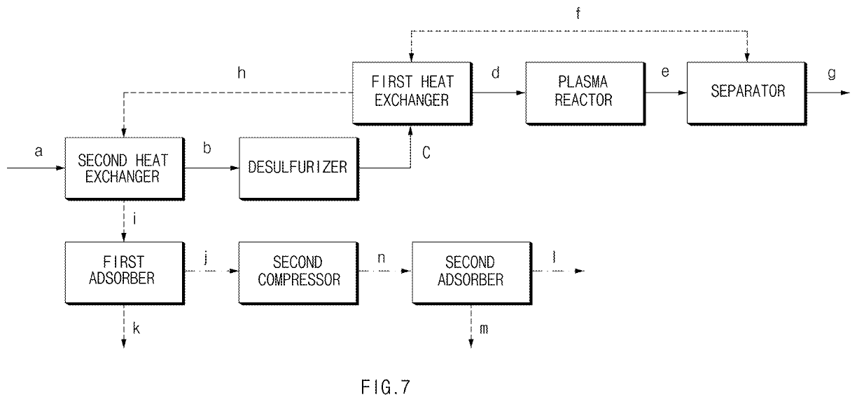

Referring to FIG. 7, the apparatus for producing a hydrogen gas according to the present disclosure may include the second heat exchanger that exchanges heat between the hydrocarbon containing gas “a” before being introduced into the desulfurizer and the low-purity hydrogen gas “h” that exchanged heat in the first heat exchanger, the desulfurizer that desulfurizes the hydrocarbon containing gas “b” that exchanged heat in the second heat exchanger, the first heat exchanger that exchanges heat between the desulfurized hydrocarbon containing gas “c” and the low-purity hydrogen gas “f” separated by the separator, the plasma reactor that generates the hydrogen containing gas “e” from the hydrocarbon containing gas “d” that exchanged heat in the first heat exchanger and was desulfurized, through plasma based pyrolysis, the separator that separates side-products “g” including the low-purity hydrogen gas “f” and carbon from the exchanged heat in the second heat exchanger to the first high-purity hydrogen gas “k” and the first off gas “j” through adsorption, the second compressor that compresses the first off gas “j” discharged from the first adsorber, and the second adsorber that separates the first off gas “n” compressed by the second compressor to the second high-impurity hydrogen gas “m” and the second off gas “1” through adsorption.

The apparatus for producing a hydrogen gas may further include a flare stack that burns and discharges the second off gas.

### Flare Stack

The first off gas separated by the second adsorber may be burned in the flare stack and be discharged to the air. Then, any device that may be applied to generally burn a gas and discharge the gas to the air may be applied as the flare stack without particular limitation.

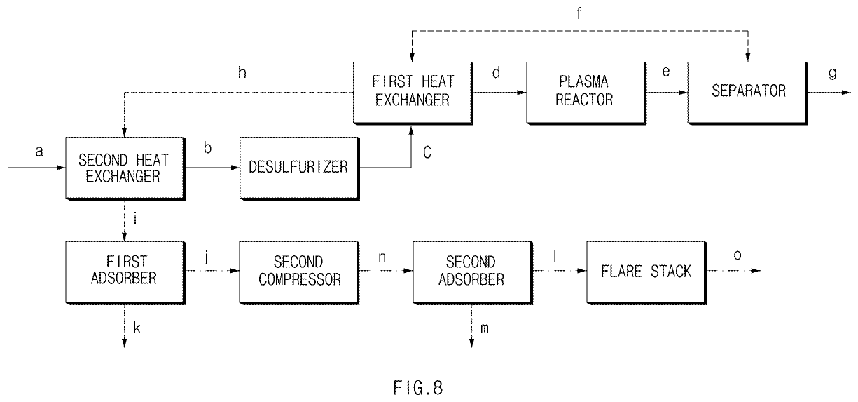

Referring to FIG. 8, the apparatus for producing a hydrogen gas according to the present disclosure may include the second heat exchanger that exchanges heat between the hydrocarbon containing gas “a” before being introduced into the desulfurizer and the low-purity hydrogen gas “h” that exchanged heat in the first heat exchanger, the desulfurizer that desulfurizes the hydrocarbon containing gas “b” that exchanged heat in the second heat exchanger, the first heat exchanger that exchanges heat between the desulfurized hydrocarbon containing gas “c” and the low-purity hydrogen gas “f” separated by the separator, the plasma reactor that generates the hydrogen containing gas “e” from the hydrocarbon containing gas “d” that exchanged heat in the first heat exchanger and was desulfurized, through plasma based pyrolysis, the separator that separates side-products “g” including the low-purity hydrogen gas “f” and carbon from the hydrogen containing gas “e”, the first adsorber that separates the low-purity hydrogen gas “i” that exchanged heat in the second heat exchanger to the first high-purity hydrogen gas “k” and the first off gas “j” through adsorption, the second compressor that compresses the first off gas “j” discharged from the first adsorber, the second adsorber that separates the first off gas “n” compressed by the second compressor to the second high-impurity hydrogen gas “m” and the second off gas “l” through adsorption, and the flare stack that burns and discharges the second off gas “l”.

The apparatus for producing a hydrogen gas according to the present disclosure may further include, between the second heat exchanger and the first adsorber, a cooler and a first compressor.

### Cooler and First Compressor

The cooler functions to enhance an adsorption efficiency of the first adsorber by cooling the low-purity hydrogen gas that exchanged heat in the second heat exchanger.

In detail, the temperature of the low-purity hydrogen gas that exchanged heat in the second heat exchanger may be 150° C. to 700° C. or 200° C. to 650° C., in certain embodiments. That is, the low-purity hydrogen gas that is discharged after exchanging heat in the second heat exchanger is of a high temperature. Accordingly, the producing apparatus according to the present disclosure may further include the cooler that cools the low-purity hydrogen gas that was discharged after exchanging heat in the second heat exchanger before being adsorbed by the first adsorber to enhance adsorption efficiency.

Furthermore, any device that may lower the temperature of the hydrogen gas may be used without any particular limitation, and for example, may be a heat exchange type cooler. Then, the heat exchange type cooler may cool the hydrogen gas by exchanging heat between a refrigerant and the hydrogen gas, and the refrigerant, for example, may include water, an antifreeze, and a thermal medium oil.

A temperature of the low-purity hydrogen gas cooled by the cooler may be 10° C. to 80° C. or 10° C. to 60° C., in certain embodiments. When the temperature of the cooled low-purity hydrogen gas is less than the range, economic efficiency may decrease due to excessive cooling, and when the temperature is more than the range, the adsorption agent filled in the first adsorber may be damaged.

The first compressor functions to enhance an adsorption efficiency by compressing the low-purity hydrogen gas cooled by the cooler. When the performance of the second adsorber is made by the PSA, the adsorption effect of the impurities in the hydrogen gas becomes lower when the pressure of the supplied hydrogen gas becomes lower. Accordingly, the hydrogen gas introduced into the second adsorber may be introduced into the second adsorber after being compressed by the second compressor.

Furthermore, any device that may be used to generally compress the hydrogen gas may be used as the second compressor without any particular limitation.

Then, the pressure of the low-purity hydrogen gas compressed by the second compressor may be 0.5 MPa to 5.0 MPa or 1.0 MPa to 3.5 MPa, in certain embodiments. When the pressure of the low-purity hydrogen gas compressed by the second compressor is less than the range, the effect of adsorbing impurities in the low-purity hydrogen gas in the second adsorber decreases, and when the pressure is more than the range, the adsorption agent filled in the second adsorber may be damaged.

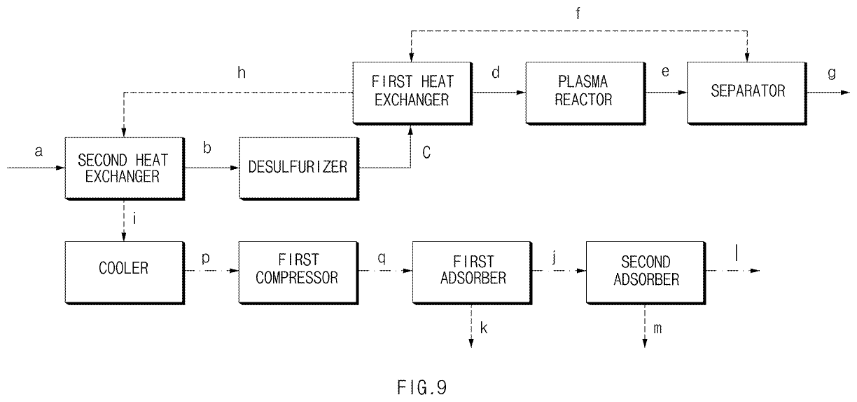

Referring to FIG. 9, the apparatus for producing a hydrogen gas according to the present disclosure may include the second heat exchanger that exchanges heat between the hydrocarbon containing gas “a” before being introduced into the desulfurizer and the low-purity hydrogen gas “h” that exchanged heat in the first heat exchanger, the desulfurizer that desulfurizes the hydrocarbon containing gas “b” that exchanged heat in the second heat exchanger, the first heat exchanger that exchanges heat between the desulfurized hydrocarbon containing gas “c” and the low-purity hydrogen gas “f” separated by the separator, the plasma reactor that generates the hydrogen containing gas “e” from the hydrocarbon containing gas “d” that exchanged heat in the first heat exchanger and was desulfurized, through plasma based pyrolysis, the separator that separates side-products “g” including the low-purity hydrogen gas “f” and carbon from the hydrogen containing gas “e”, the cooler that cools the low-purity hydrogen gas “i” that exchanged heat in the second heat exchanger, the first compressor that compresses the low-purity hydrogen gas “p” cooled by the cooler, the first adsorber that separates the low-purity hydrogen gas “q” compressed by the first compressor to the first high-purity hydrogen gas “k” and the first off gas “j” through adsorption, and the second adsorber that separates the first off gas “j” to the second high-purity hydrogen gas “m” and the second off gas “l” through adsorption.

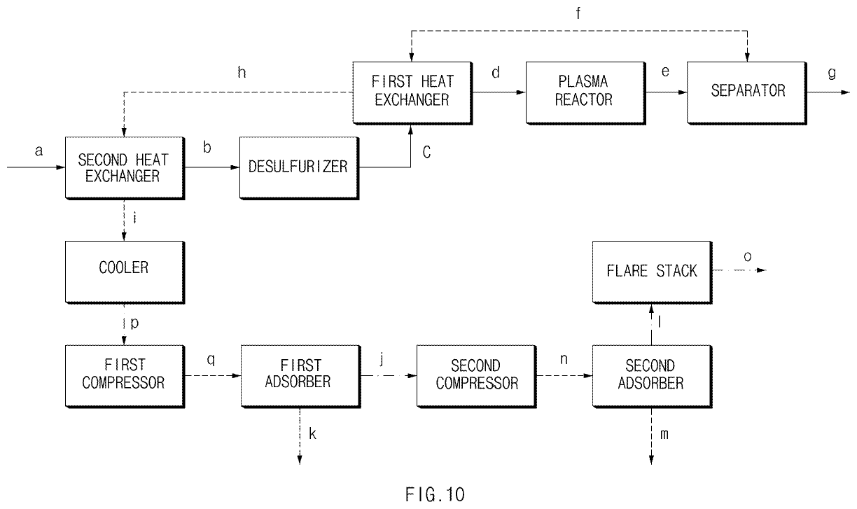

Referring to FIG. 10, the apparatus for producing a hydrogen gas according to the present disclosure may include the second heat exchanger that exchanges heat between the hydrocarbon containing gas “a” before being introduced into the desulfurizer and the low-purity hydrogen gas “h” that exchanged heat in the first heat exchanger, the desulfurizer that desulfurizes the hydrocarbon containing gas “b” that exchanged heat in the second heat exchanger, the first heat exchanger that exchanges heat between the desulfurized hydrocarbon containing gas “c” and the low-purity hydrogen gas “f” separated by the separator, the plasma reactor that generates the hydrogen containing gas “e” from the hydrocarbon containing gas “d” that exchanged heat in the first heat exchanger and was desulfurized, through plasma based pyrolysis, the separator that separates side-products “g” including the low-purity hydrogen gas “f” and carbon from the hydrogen containing gas “e”, the cooler that cools the low-purity hydrogen gas “i” that exchanged heat in the second heat exchanger, the first compressor that compresses the low-purity hydrogen gas “p” cooled by the cooler, the first adsorber that separates the low-purity hydrogen gas “q” compressed by the first compressor to the first high-purity hydrogen gas “k” and the first off gas “j” through adsorption, the second compressor that compresses the first off gas “j” discharged from the first adsorber, the second adsorber that separate the first off gas “n” compressed by the second compressor to the second high-purity hydrogen gas “m” and the second off gas “l” through adsorption, and the flare stack that burns and discharges the second off gas “l”.

Since a purity of the hydrogen produced by the apparatus for producing a hydrogen gas according to the present disclosure, which has been described above, is as high as 99.97% or more, the hydrogen may be used as a fuel for a fuel cell and the like without additional purification. Furthermore, the apparatus for producing the hydrogen gas has an excellent energy efficiency because it uses the wasted heat of the produced hydrogen to preheat the material.

Hereinafter, the present disclosure will be described in more detail through the embodiments. However, the embodiments are provided simply to help understanding of the present disclosure and the scope of the present disclosure is not limited to the embodiments in any meaning.

### EMBODIMENT

### First Embodiment: Producing of Hydrogen Gas

The hydrogen gas was produced by using the apparatus for producing a hydrogen gas, which has the structure of FIG. 5. Then, methane gas was used as the hydrocarbon containing gas “A” that is the material, and an amount of the first off gas “J” corresponding to 50 volume % of the total volume thereof was introduced into the second compressor. A reactor using microwave plasma of a high temperature of 1,000° C. or more was used as the plasma reactor, and a heat exchange type cooler using cooling water was used as the cooler. Moreover, a temperature of the hydrogen gas “F” separated by the separator was 1,500±300° C., and a temperature of the hydrogen gas “H” discharged after exchanging heat in the first heat exchanger was 1,000±150° C. Furthermore, a temperature of the hydrogen gas discharged after exchanging heat in the third heat exchanger was 500±300° C., and a temperature of the hydrogen gas “O” cooled by the cooler was 40±20° C. Moreover, a pressure of the hydrogen gas “P” compressed by the first compressor was 2.0±1.0 MPa, and the first adsober including four adsorption towers filled with active carbon was used. Furthermore, a pressure of the hydrogen gas “L” compressed by the second compressor was 2.0±1.0 MPa.

A system efficiency of the produced hydrogen gas was calculated through a method using hydrogen gas “H₂”/(electricity+hydrocarbon containing gas “A”) (an enthalpy-based calorie). Then, the apparatus were designed to suitable for ISO 14687, and the results are represented in Table 1.

### Second Embodiment

A hydrogen gas was produced through the same method as that of the first embodiment, except that an amount of the first off gas “J” corresponding to 83 volume % of the total volume thereof was introduced into the second compressor.

### Third Embodiment

The hydrogen gas was produced by using the apparatus for producing a hydrogen gas, which has the structure of FIG. 10. Then, a methane gas was used as the hydrocarbon containing gas “a” that is a material, and the second adsorber including four adsorption towers filled with active carbon was used.

A method for calculating or measuring system efficiencies and purities of the produced hydrogen gases was the same as that of the first embodiment, and the results are represented in Table 1.

### Comparative Example 1

A hydrogen gas was produced through the same method as that of the third embodiment, except that the second compressor, the second adsorber, and the flare stack in FIG. 10 were not used, and the results are represented in Table 1.

TABLE 1

| | | Comparative | First | Second | Third |
|---|---|---|---|---|---|
| | Unit | example 1 | Embodiment 1 | Embodiment 2 | Embodiment 3 |
| Re-circulation | % | — | 50 volume % | 83 volume % | — |
| Rate of Off Gas | | | | | |
| Feed gas | Nm³/hr | 133.7 | 118.2 | 107.9 | 109.5 |
| Electricity | kW | 370 | 309.6 | 306.2 | 276 |
| Consumption | | | | | |
| Product Hydrogen | kg/d | 430 | 430 | 430 | 430 |
| System Efficiency | % | 39.4 | 45 | 48.5 | 49 |
| of Hydrogen Gas | | | | | |

As may be seen in Table 1, the system efficiencies of the hydrogen gases of the first to third embodiments were as remarkably excellent as 45% or more as compared with Comparative Example 1, and the energy efficiencies thereof were excellent as the electricity consumption were low.

Since a purity of the hydrogen produced by the apparatus for producing a hydrogen gas according to the present disclosure, which has been described above, is as high as 99.97% or more, the hydrogen may be used as a fuel for a fuel cell and the like without additional purification. Furthermore, the apparatus for producing the hydrogen gas has excellent energy efficiency because it uses the wasted heat of the produced hydrogen to preheat the material.

1. An apparatus for producing a hydrogen gas, the apparatus comprising:
a desulfurizer configured to desulfurize a hydrocarbon containing gas;
a plasma reactor configured to generate a hydrogen containing gas from the desulfurized hydrocarbon containing gas through plasma-based pyrolysis;
a separator configured to separate a low-purity hydrogen gas from the hydrogen containing gas;
a first heat exchanger configured to exchange heat between the desulfurized hydrocarbon containing gas and the low-purity hydrogen gas;
a second heat exchanger configured to exchange heat between the hydrocarbon containing gas and the low-purity hydrogen gas that exchanged heat in the first heat exchanger;
a first adsorber configured to separate the low-purity hydrogen gas that exchanged heat in the second heat exchanger into a first high-purity hydrogen gas and a first off gas, through adsorption; and
a second adsorber configured to separate the first off gas to a second high-purity hydrogen gas and a second off gas through adsorption.

2. The apparatus of claim 1, further comprising between the second heat exchanger and the first adsorber:
a cooler configured to cool the low-purity hydrogen gas that exchanged heat in the second heat exchanger; and
a first compressor configured to compress the low-purity hydrogen gas cooled in the cooler.

3. The apparatus of claim 1, further comprising between the first adsorber and the second adsorber:
a second compressor configured to compress the first off gas that is discharged from the first adsorber.

4. The apparatus of claim 1, further comprising:
a flare stack configured to burn and discharge the second off gas.

5. The apparatus of claim 1, further comprising:
at least one of the first adsorber and the second adsorber performs pressure swing adsorption (PSA).
